(19) United States
(12) Patent Application Publication
(10) Pub. No.: US 2019/0307621 A1
(43) Pub. Date: Oct. 10, 2019

(54) ELECTRIC BED COMBINING MATRRESS

(71) Applicant: EMONS FUNITURE CO., LTD, lncheon (KR)

(72) Inventor: KYOUNG SOO KIM, Seoul (KR)

(21) Appl. No.: 16/231,678

(22) Filed: Dec. 24, 2018

(30) Foreign Application Priority Data
Apr. 5, 2018 (KR) 10-2018-0039712

(51) Int. Cl. A61G 7/015; A47C 20/04; A61G 7/018; A61G 7/005; A61H 1/02; A61G 7/075

(52) U.S. Cl. CPC A61G 7/015; A47C 20/04; A61G 7/018; A61H 2201/0142; A61H 1/0237; A61G 7/075; A61G 7/005

(57) ABSTRACT

The present invention relates to an electric bed combining mattress in which a bed is segmented and folded corresponding to human joints. The present invention includes: a frame part comprising a plurality of segment frames foldably connected so as to form an inclination angle with adjacent segment frames; a mattress part mounted on the frame part; a drive part configured to drive the segment frames so that the segment frames are folded; and a support part configured to support the lower portion of the frame part. Thus, the drive part is provided only to a lower region of a fixed frame, and the drive part is not exposed to lower portions of upper and lower body frames the angles of which are adjusted, so that danger of causing a safety accident is decreased, and appearance can be improved.

### CROSS-REFERENCE TO RELATED APPLICATIONS

This U.S. non-provisional patent application claims priority under 35 U.S.C. § 119 of Korean Patent Application No. 10-2018-0039712, filed on Apr. 5, 2018, the entire contents of which are hereby incorporated by reference.

### FIELD OF THE INVENTION

The present invention disclosed herein relates to an electric bed combining mattress, and more particularly, to an electric bed combining mattress in which a bed is segmented and folded according to human joints.

### BACKGROUND ART

Typical beds have a mattress on a support frame to provide a comfortable lying place. Recently, uses of an electric bed are increasing in which the upper body is raised or a leg is raised for rest, fatigue recovery, television watching, reading, or the like.

Related Korean Patent Laid-open Publication No. 10-2007-0021646 discloses a human joint-type bed including: a mattress frame which is divided into a head-support frame, a back-support frame, a hip-support frame, a thigh-support frame, and a calf-support frame that are connected to each other via hinge axes, and which is installed on a bed frame; an angle adjustment device which is provided with: a supporter installed on the head frame; and a shock absorber installed on the supporter and having a piston rod tightly installed to the back-support frame, the angle adjustment frame raising the head-support frame around a neck joint axis serving as a pivot by forward and backward movements of the piston rod; and a single-joint forward and backward movement device in which the mattress frame slides forward and backward, wherein, formation of a bed rear space is prevented and thus, a problem in which an object falls to the space is prevented.

Korean Patent No. 10-1799971 discloses a body portion arrangement angle-adjustable electric bed frame which includes: a base frame in which a mattress mounting space is formed; a support frame including a head frame, a waist frame, a hip frame, a leg frame, and a foot frame which are pin-coupled to each other; an actuator link module which is installed under the support frame and adjusts the heights and arrangement angles of respective portions constituting the support frame, wherein the heights and the arrangement angles of the head frame and the waist frame.

Korean Patent No. 10-0900878 discloses, with regard to a patient bed having an actuation frame on which a mattress is mounted and which can be inclined at a predetermined angle in order that a user can obliquely raise and incline, at predetermined angles, the body portions such as the head, the back and waist, or the leg and can comfortably lie on the bed, a back plate angle-adjusting device for patent beds, which includes: a drive shaft which is installed under an actuation frame and generates a torque; a universal joint attached to one end portion of the drive shaft to transmit the torque to a screw axis on the other side; and a lifting means for actuating the actuation arm attached under the actuation frame while folded in a four-segment link assembled to the screw shaft.

The above-mentioned typical electric bed had an angle-adjustable movable frame installed on a bed frame and thus had a disadvantage in that a drive device for adjusting the inclination angle of the movable frame from the bed frame and lifting the movable frame and a link member for supporting the movable frame were exposed under the raised movable frame to thereby cause a safety accident of being jammed in the drive device and the link member, and spoil the appearance of the bed.

In addition, when adjusting the angle of the movable frame, there was a limitation in that the bed is shaken according to a movement of a user or the center of gravity was moved to one side of the movable frame to thereby cause load concentration.

Meanwhile, in order that a user of an existing bed uses an electric bed, the existing bed should be removed, and thus, there was a limitation in that burden of expenses increased and the existing bed was wasted.

### SUMMARY OF THE INVENTION

To solve the above-mentioned limitations, the present invention provides an electric bed combining mattress for preventing a safety accident caused by a drive device and a link member and improving appearance.

The present invention also provides an electric bed combining mattress which does not shake even when the angle of a movable frame is adjusted and in which a load is uniformly distributed.

In addition, the present invention provides an electric bed combining mattress which can reduce the burden of replacement expenses by appropriately recycling an existing bed.

In accordance with an embodiment of the present invention, an electric bed combining mattress includes: a frame part comprising a plurality of segment frames foldably connected so as to form an inclination angle with adjacent segment frames; a mattress part mounted on the frame part; a drive part configured to drive the segment frames so that the segment frames are folded; and a support part configured to support the lower portion of the frame part.

The plurality of segment frames may be divided into and include an upper body frame, a fixed frame, and a lower body frame, wherein the fixed frame may be fixed to the support part, and the upper body frame, and the lower body frame may be foldably connected so as to respectively form inclination angles with the fixed frame.

The lower body frame may include a plurality of segment frames foldably connected to the fixed frame.

The lower body frame may include a plurality of segment frames foldably connected to the fixed frame.

The frame part may include laying plates which are provided on an upper portion thereof and in which a plurality of wire parts cross each other, wherein the mattress part may be deflected by the weight thereof into respective spaces between the wire parts.

The frame part may include auxiliary frame parts on a lower peripheral portions thereof formed by division of segmented portions of the frame part.

The auxiliary frame members may be formed of high-hardness elastic bodies.

The frame part may include protective members each configured to cover an outside of a peripheral portion thereof, wherein the protective members may each have a portion corresponding to a segmented portion of the frame part and formed of a material having relatively higher stretchability than other portions.

The portion formed of the material having high stretchability may be formed to be gradually widened downward.

The electric bed combining mattress may further include an upper mat part provided on the mattress part and attached to/detached from a first cover configured to surround outside surfaces of the frame part and the mattress part.

The drive part may include: an upper body drive part configured to drive the upper body frame; and a lower body drive part configured to drive the lower body frame, wherein the upper body drive part and the lower body drive part may be provided only to a lower region of the fixed frame.

The support part may include: support members; and fixing members configured to fix the fixed frame to the support members, wherein the support members may each include at least two or more vertical support members disposed to be elongated in the longitudinal direction of the mattress part.

The support members may each further include horizontal support members configured to connect the adjacent vertical support members.

The support members may each further include auxiliary support members extending toward insides of respective vertical support members.

The support part may further include a separation members detachably coupled to lower portions of the support members and configured to separate the support members from a support surface.

In accordance with an electric bed combining mattress of the present invention, a drive part is provided only to a lower region of a fixed frame and is not exposed to lower portions of upper and lower body frames having an adjustable angle, so that danger of causing a safety accident is decreased, and appearance can be improved.

In addition, in accordance with the present invention, the fixed frame is supported by a support part, so that even when the angles of segment frames of a frame part are adjusted, the bed can be supported with shaking, and a load can be uniformly distributed through the fixed frame.

In addition, an electric bed in accordance with the present invention is installed on an upper portion of a supporter of an existing bed and is used in place of a mattress, so that the existing supporter can be reused and thus burden of replacement costs can be reduced.

In addition, in accordance with the present invention, a plurality of segment frames are folded so as to form inclination angles, so that a comfortable attitude can be maintained according to human joints.

In addition, in accordance with the present invention, a laying plate is provided and a mattress part is deflected into spaces between wire parts, so that the mattress part can be prevented from sliding relative to the frame part.

In addition, in accordance with the present invention, a detachment prevention guide is provided, so that even when the frame part forms inclination angles, the mattress part can be prevented from sliding.

In addition, in accordance with the present invention, an auxiliary frame members are provided, so that the drive part under the frame part is protected, and when the inclination angles of the frame part are formed, wrinkles of a first cover can be prevented, and a jamming accident in the frame part can be prevented.

In addition, in accordance with the present invention, a protective member is provided, so that the frame part can be smoothly operated when forming inclination angles even while mitigating external shocks to the frame part.

In addition, in accordance with the present invention, an attachable/detachable upper mat part is provided, so that the hardness of the mat part can be determined according to user's preference, and the mat part can be easily replaced and thereby maintained to be clean.

In addition, in accordance with the present invention, a separation member is provided, so that the electric bed combining mattress can be used by being selectively installed on the upper portion of a supporter or a bottom surface, and may also be used by being separated from a support surface without a supporter.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view according to an embodiment of the present invention;

FIG. 2 is a perspective view illustrating a coupling relationship between first and second cover parts according to the embodiment of the present invention;

FIG. 3 is a plan view according to an embodiment of the present invention;

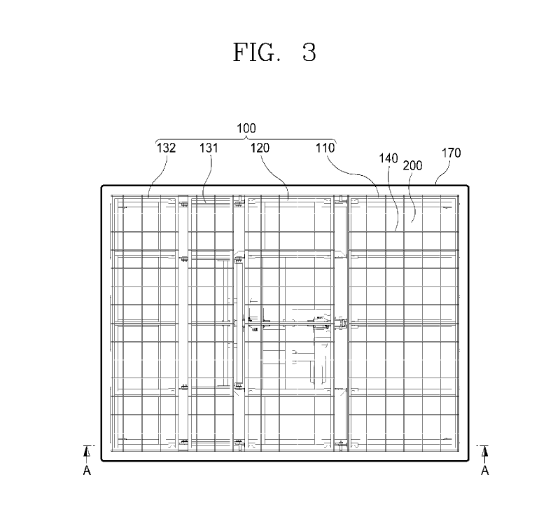

FIG. 4 is a cross-sectional view taken along line AA of FIG. 3;

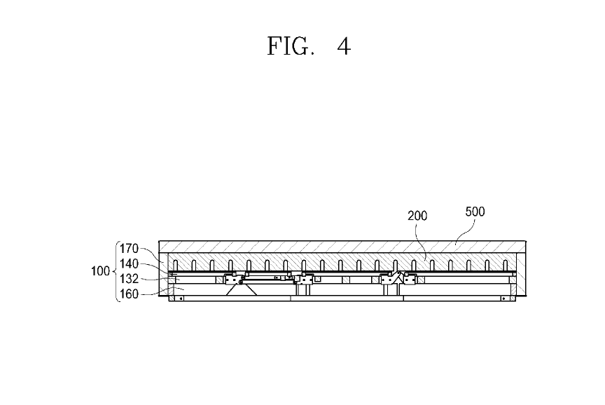

FIG. 5 is a perspective view illustrating a frame part and a support of the present invention;

FIG. 6 is a perspective view illustrating a state in which a laying plate is added;

FIG. 7 is a perspective view illustrating a state in which a subframe member is added;

FIG. 8 is a perspective view illustrating a state in which a mattress part is added;

FIG. 9 is a perspective view illustrating a state in which a protective member is added;

FIG. 10 is a perspective view illustrating a state of surrounded by a first cover;

FIG. 11 is a perspective view illustrating a state in which an upper mat part is added;

FIG. 12 is a cross-sectional view illustrating a coupling relationship between the laying plate and the mattress part;

FIG. 13 is a perspective view illustrating a portion of the protective member according to an embodiment, the portion being formed of a highly stretchable material;

FIG. 14 is a perspective view illustrating a portion of the protective member according to another embodiment, the portion being formed of a highly stretchable material;

FIG. 15 is a perspective view of a planar frame part when viewed from top;

FIG. 16 is a perspective view of a planar frame part when viewed from bottom;

FIG. 17 is a perspective view of a folded state of a frame part when viewed from top;

FIG. 18 is a perspective view of a folded state of a frame part when viewed from bottom;

FIG. 19 is a perspective view of a state in which a frame part is folded at a larger angle when viewed from top;

FIG. 20 is a perspective view of a state in which a frame part is folded at a larger angle when viewed from bottom; and

FIG. 21 is a perspective view of a frame part provided with a spatial member when viewed from bottom.

### DETAILED DESCRIPTION OF THE PREFERRED EMBODIMENTS

Hereinafter embodiments of the present invention will be described in detail with reference to accompanying drawings. In the electric bed combining mattress according to the present invention: the bed is operated so as to be segmented and folded according to human joints in order that a user can rest, recover fatigue, watch television, read, or the like; a driven frame part is integrally driven with a mattress part, so that s drive part is not exposed, and a separate link member for support the inclination angle of the frame part is not provided, and thus, jamming accident can be prevented and the appearance can be improved.

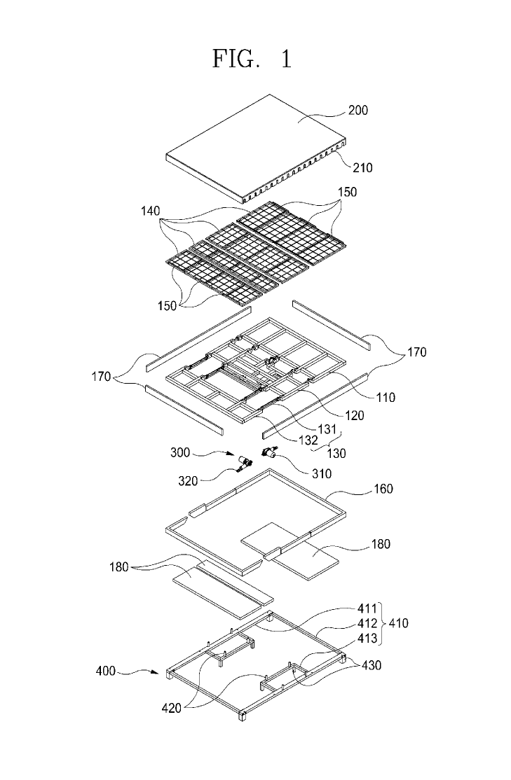

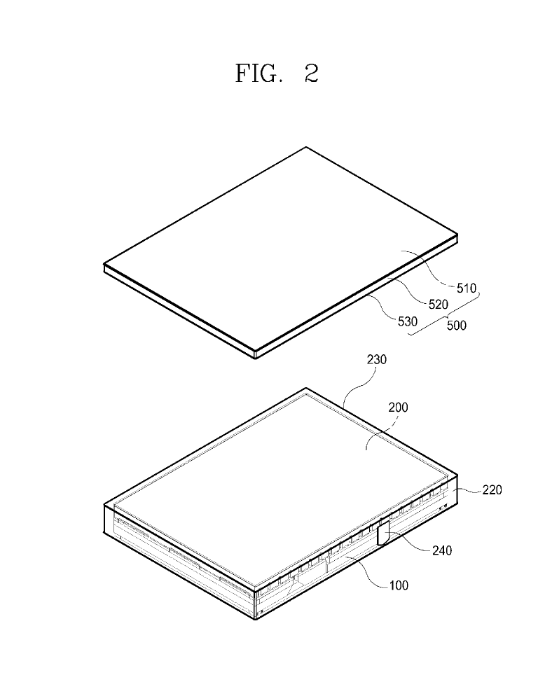

As illustrated in FIGS. 1 and 2, an electric bed combining mattress of the present invention includes a frame part 100, a mattress part 200, a drive part 300, a support part 400, and an upper mat part 500.

The frame part 100 includes a plurality of segment frames. A segment frame is foldably connected so as to form an inclination angle with an adjacent segment.

The plurality of segment frames are divided into an upper body frame 110, a fixed frame 120, and a lower body frame 130.

The upper body frame 110 is foldably connected to the fixed frame 120 so as to form an inclination angle with the fixed frame, and supports the portion of user's upper body.

The fixed frame 120 is provided between the upper body frame 110 and the lower body frame 130, is fixed to the support part 400, and supports the portions of user's waist and hip.

The lower body frame 130 is foldably connected to the fixed frame 120 so as to form an inclination angle with the fixed frame, supports the portion of user's lower body, and may include a plurality of segment frames foldably connected to the fixed framed 120.

The lower body frame 130 may be divided into: a first lower body frame 131 which is foldably connected to the fixed frame 120 so as to form an inclination angle with the fixed frame and supports the portion of user's thigh; and a second lower body frame 132 which is foldably connected to the first lower body frame and supports the portions of user's feet and calves. The first and second lower body frames 131 and 132 may be folded as the frame part is segmented according to the knee joints of the user, the user may maintain a further comfortable attitude.

The fixed frame 120 may have an inclination angle with respect to a support surface, but may preferably be fixed to the support part 400 in a horizontal state.

At this point, it is desirable that an upper angle between the upper body frame 110 and the first lower body frame 131 be an inferior angle (less than 180°), and an upper angle between the second lower body frame 132 and the fixed frame 120 be a superior angle (greater than 180°).

Accordingly, from the portions of user's waist and hip, the upper body is raised and the lower body is lifted. At this point, since the first and second lower body frames 131 and 132 forms a superior angle, a state in which the knees are appropriately folded may be maintained even while the legs are lifted according to the knees.

The frame part 100 may further include laying plates 140, detachment prevention guides 150, subframe members 160, and supporting members 170.

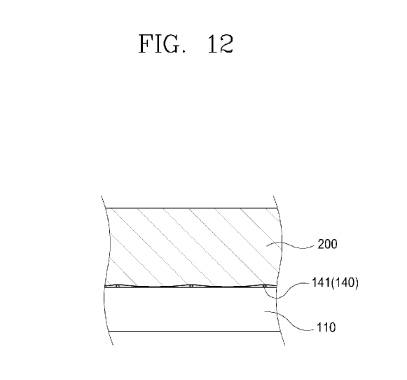

The laying plate 140 is provided over the segment frame, and has a shape, such as a shape of a net or a wire mesh, in which a plurality of wire parts cross. As illustrated in FIG. 12, the mattress part 200 is mounted on the laying plate 140 and the mattress part 200 falls to each of spaces between wire parts 141 by the weight thereof. Accordingly, the wire parts 141 becomes inserted into a lower portion of the mattress part 200, and when an inclination angle of an electric bed is formed, the mattress part 200 may be prevented from sliding relate to the frame part 100.

The detachment prevention guides 150 are provided on both longitudinal ends of the frame part 100 and prevent the detachment of the mattress part 200. When the segment frames are folded, deflections are formed in the frame part 100. At this point, the mattress part 200 is prevented from being detached toward the outside in the longitudinal direction of the frame part 100.

The detachment prevention guides 150 protrude upward from the frame part 100 and may be provided on end portions of the laying plate 140 or on end portions of the segment frames.

The subframe members 160 are provided on lower peripheral portions of the frame part 100 and are formed by the division of segmented portions of the frame part 100. That is, the subframe members 160 are respectively coupled to the segment frames and are provided to the entire peripheral portion of the plurality of segment frames. The subframe members 160 protect the drive part 300 provided under the frame part 100, and when the frame part 100 is folded, the subframe member 160 suppress wrinkles of a first cover 220 surrounding the frame part 100 and the mattress part 200 to thereby improve the appearance. In addition, since the subframe members 160 are formed to be divided, the subframe members may individually be driven by the respective segment frames when the frame part 100 is folded, and thus, the folding operation of the frame part 100 may be smooth.

At this point, the space between the subframe members 160 respectively coupled to first and second lower body frames 131 and 132 may favorably be formed to be gradually wider downward. Accordingly, even when the first and second lower body frames 131 and 132 are folded at a superior angle, the interference with the subframe members 160 may be prevented.

Such subframe members 160 may be formed of an elastic body having high hardness. Accordingly, when the frame part 100 is deformed from a folded state to a planar state, shock may be mitigated even when a portion of the human body is jammed, and damage may be prevented even when an object is jammed.

The protective member 170 is a member covering the outside of a peripheral portion of the frame part 100 and may be formed by being connected each other to cover the entire peripheral portion of the frame part 100. The protective member 170 may mitigate shocks from side surfaces and assist the function of maintaining the shapes of the frame part 100 and the mattress part 200 when the frame part 100 is folded.

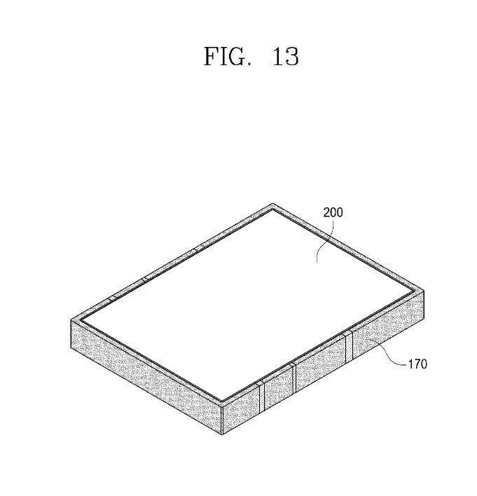

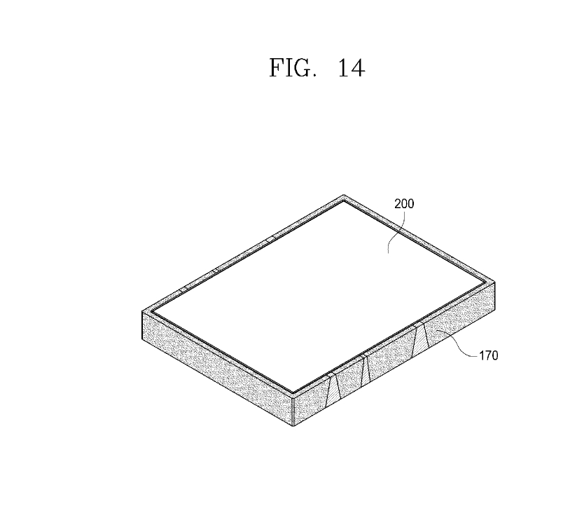

Such protective members 170, as illustrates in FIGS. 13 and 14, portions corresponding to a segmented portions of the frame part 100 may be formed of a material having a relatively higher stretchability than the other portions. For example, the portions corresponding to the segmented portions of the frame part 100 are formed of a soft material and the other portions are formed of a hard material. Accordingly, the stretchability of the segmented portions is increased, so that an interference with an adjacent segment frame may be minimized.

The hatched portions in FIGS. 13 and 14 are the portions formed of a material having high stretchability. In FIG. 13, the width of the portions formed of a material having high stretchability is the same according the height. Meanwhile, when folding the segment frames, the further downward from the respective folding rotation centers, the longer the stretched length. Therefore, as illustrated in FIG. 14, the width of the portions formed of the material having high stretchability may be formed gradually wider downward. Conversely, between the first and second lower body frames 131 and 132, the further downward from the respective folding rotation centers, the longer the contracted length. Therefore, it is favorable that the width of the portions formed of the material having high stretchability may be formed gradually wider downward.

Favorably, the upper ends of the protective members 170 are disposed to have the same height as the upper end of the mattress part 200, and the lower end of the protective members 170 are disposed to have the same height as the lower end of the subframe members 160.

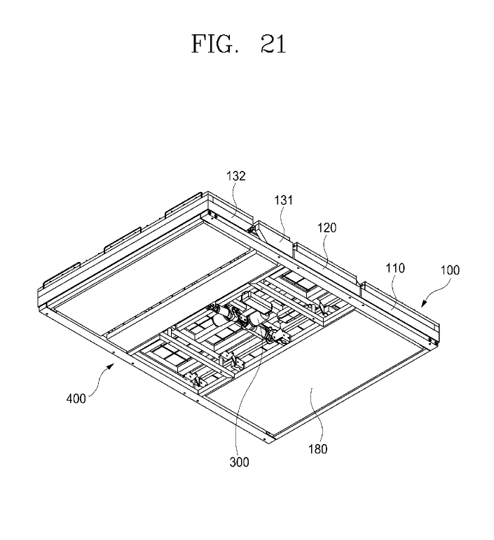

In the frame part 100, as illustrated in FIG. 21, lower spaces of the upper and lower body frames 110 and 130 may be filled with an elastic space members 180. The space members 180 may favorably fill the spaces up to the same height as the lower ends of the subframe members 160 and the protective members 170. Accordingly, wrinkles of the first cover 120 may be suppressed to maintain the shape. In addition, even when a jamming accident occurs under the upper and lower body frames 110 and 130, shock may be mitigated by an elastic body, and a problem of being locked in the lower spaces surrounded by the subframe members 160 and the protective members 170. Such space members 180 may be formed of elastic sponges, forms, foamed bodies, or the like.

The mattress part 200 is mounted on the frame part 100. The mattress part 200 is formed of a sponge, a form, a foamed body, or the like, and provides a stable use feeling.

Such mattress part 200 may be provided with grooves 210 which are formed, in at least one of the upper surface and lower surface of the mattress part, to be elongated in a direction perpendicular to the longitudinal direction of the mattress part 200. The grooves 210 increase the flexibility of the mattress part 200, which forms deflection together with the frame part 100 when the frame part 100 is folded, and thereby prevents the folding and wrinkle of the mattress part 200. In FIG. 1, grooves 210 are formed in the lower surface of the mattress part 200, and the shapes and positions of the grooves 210 are not limited as long as the grooves increase the flexibility of the mattress part 200.

The mattress part 200 may further include a first cover 220.

The first cover 220 surrounds both the outer surfaces of the frame part 100 and the mattress part 200. Accordingly, the mattress part 200 is prevented from being detached from the frame part 100 so as to be driven together with the frame part 100. In addition, the appearance of the frame part 100 and the mattress part 200 is improved, and a jamming accident or the like caused between the driven segment frames is prevented.

The first cover 220 may be provided with, on a surface thereof, a first coupling member 230 and an accommodation member 240.

The first coupling member 230 is member for coupling, to the first cover 220, the upper mat part 500 mounted on the mattress part 200. Accordingly, the upper mattress part 500 may be provided with a second coupling member 530 coupled to the first coupling member 230.

As illustrated in FIG. 2, the first coupling member 230 may be formed as a zipper provided on an upper peripheral portion of the first cover 220, and the second coupling member 530 may be formed as a zipper which is provided on a lower peripheral portion of the upper mat part 500 and is coupled to the first coupling member 230.

At this point, when the frame part 100 is folded, sliding occurs at facing surfaces according to the formation of deflection of the mattress part 200 and the upper mat part 500. Considering this, the width of the zipper is sufficiently ensured to provide an allowable space in which the mattress part 200 and the upper mat part 500 may slide. Although not shown in the drawings, coupling members such as buttons, velcros or bands, may be used for the first and second coupling members which may fix the mattress part and the upper mat part.

The accommodation member 240 is favorably provided on a side surface of the first cover 220, is formed in a pocket shape, and accommodates a remote controller for operating the drive part 300, a sensor provided on the mattress part 200 to detect bio signals of a user, and the like.

Although not shown in the drawings, the first cover may have an opening/closing part formed on a lower portion thereof. The opening/closing part may open the first cover when a failure occurs in the drive part under the frame part to thereby facilitate the repair, replacement, or the like of the drive part.

The drive part 300 drives the frame part 100 so that segment frames are folded, and includes an upper body drive part 310 and a lower body drive part 320.

The upper body drive part 310 drives the upper body frame 110, and the lower body drive part 320 drives the lower body frame composed of first and second lower body frames 131 and 132.

The upper and lower body drive parts 310 and 320 are provided only to a lower region of the fixed frame 120. That is, the drive part 300 is provided only to the lower region of the fixed frame 120 regardless of the planar state or the folded state of the frame part 100. Accordingly, even when an inclination angle is formed in the upper and lower body frames 110 and 130, a separate member for supporting the upper and lower body frames 110 and 130 is not provided in the lower regions of the upper and lower body frames 110 and 130. Thus, the driven frame part 100 may integrally be operated with the mattress part 200.

As the frame part 100 and the mattress part 200 are integrally operated, the drive part 300 is not exposed under the upper and lower body frames 110 and 130 which form an inclination angle, and thus, a safety accident such as jamming accident may be prevented, and the appearance may be improved.

In addition, the electric bed combining mattress according to the present invention may be installed on a supporter (mattress support frame) of an existing bed and may be used in place of an existing mattress. Accordingly, difficulty in entirely replacing the supporter and the mattress of an existing bed that has been used and a cost loss problem may be solved. Meanwhile, the electric bed combining mattress according to the present invention may be used by being directly installed on a support surface without a separate bed supporter.

The upper and lower body drive parts 310 and 320 may be formed of cylinders. Accordingly, the segment frames are operated according to changes in lengths of the respective cylinders. Specifically, when the length of the upper body drive part 310 increases, the inclination angle of the upper body frame 110 connected to the upper body drive part increases, and when the length of the lower body drive part 320 increases, the inclination angle of the first lower body frame 310 connected to the lower body drive part increases. The second lower body frame 320 is connected to the fixed frame 120 via the first lower body frame 310, the inclination angle of the second lower body frame 320 is determined according to the formation of the inclination angle of the first lower body frame 310. Accordingly, the lower body drive part 320 simultaneously drives the first and second lower body frames 310 and 320 according to the changes in the lengths.

The support 400 supports the lower portion of the frame part 100. The support part 400 may include support members 410, fixing members 420, and separation members 430.

The support members 410 may be divided into vertical support members 411, horizontal support members 412, and auxiliary support members 413, and may include at least the vertical support members 411 while the horizontal support members 412 and auxiliary support members 413 are not provided.

The vertical support members 411 are at least two or more support members which are disposed to be elongated in the longitudinal direction of the mattress part 200. While the frame part 100 and the mattress part 200 are folded, the vertical support members 411 prevent the electric bed from being shaken and overturn and prevent load concentration, due to the movement of the weight of a user.

The horizontal support members 412 connect the adjacent vertical support members 411. The horizontal support members 412 increase the support capability of the adjacent vertical support members 411. The horizontal support members 412 may be detachably connected to the vertical support members 411 and whether to use the horizontal support members may be determined according to the user/s request. In particular, when the electric bed is not assembled and coupled to a bed supporter, the horizontal support members 412 are provided to mitigate overturn of the electric bed or load concentration.

The auxiliary support members 413 extend inward to the respective vertical support members 411. Accordingly, the supporting capability of the vertical support members 411 is increased. The auxiliary support members 413 are favorably formed to extend at positions corresponding to a lower region of the fixed frame 120, and increase coupling positions or the coupling areas between the frame part 100 and the support members 410 by the fixing members 420 to thereby improve the fixing capability of the fixed frame 120 to the support members 410.

The fixing members 420 fix the fixed frame 120 to the support members 410.

The separation members 430 are detachably coupled to lower portions of the support members 410 and separate the support members 410 from a support surface. Accordingly, a user may use the electric bed so as to be separated from the support surface even without a bed supporter. Since the separation members 430 are detachable, whether to use the separation members may be determined according to user's request.

Such separation members 430 are favorably provided to both ends of the respective vertical support members 411, and may also be provided to the respective auxiliary members 413 inside the vertical support members 411.

The upper mat part 500 is provided on the mattress part 200 and is attached to/detached from the first cover 220 which surrounds the outside surfaces of the frame part 100 and the mattress part 200.

The upper mat part 500 includes upper mattress 510, a second cover 520, and a second coupling member 530.

The upper mattress 510 is formed of sponges, forms, foamed bodies, and the like mounted on the mattress part 200, and is manufactured to have various hardness according to materials of the upper mattress 510 to widen the selection region of a user.

For example, according to hardness, the material for the upper mattress 510 may be selected according to user's preference from among soft memory forms, hard high-density forms, and intermediate latex materials.

The second cover 520 surrounds the upper mattress 510 and is attached to/detached from the first cover 220.

The second coupling member 530 is coupled to the first coupling member 230 so that the first and second covers 220 and 520 are attached/detached.

The upper mat part 500 is simply attached to/detached from the first cover 220 which surrounds the frame part 100 and the mattress part 200. Thus, according to user's preference, the material of the upper mattress part 510 may be simply replaced, and the upper mat part 500 and the second cover 520 which direct contact a human body may be easily replaced, so that the electric bed may be sanitarily maintained.

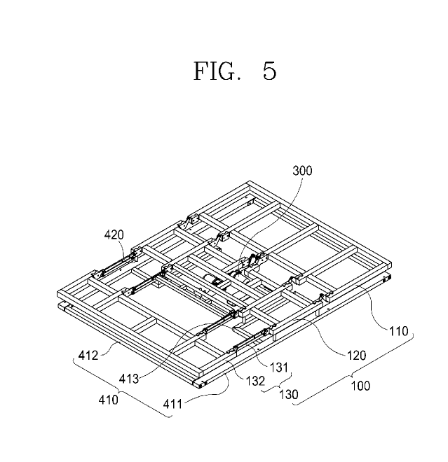

Hereinafter, with reference to FIGS. 5 to 11, coupling relationship between the components of an electric bed combining mattress according to the present invention will be described.

First, FIG. 5 illustrates the segment frames supported by the support part 400 and the drive part 300 installed under the fixed frame 120.

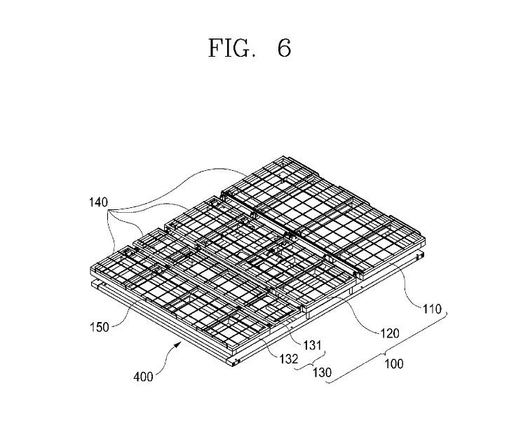

FIG. 6 illustrates a state in which laying plates 140 are mounted on the respective segment frames. The laying plates 140 on the upper body frame 110 and the second lower body frame 132 are respectively provided with detachment prevention guides 150 on the outsides thereof.

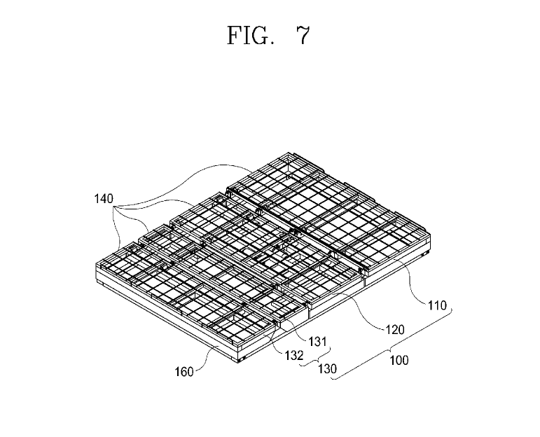

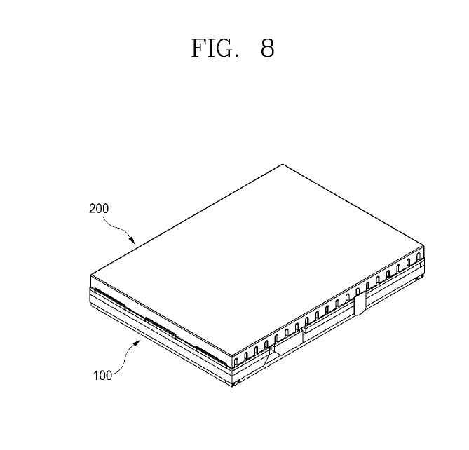

FIG. 7 illustrates a state in which the auxiliary frame members 160 are disposed on the lower peripheral portions of the segment frames, and FIG. 8 illustrates a state in which the mattress part 200 is mounted on the segment frames.

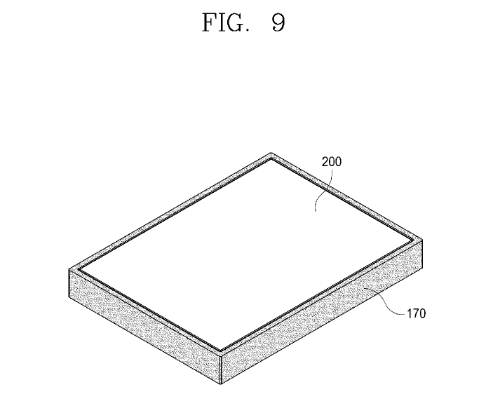

FIG. 9 illustrates a state in which the protective members 170 are provided outside the peripheral portions of the segment frames. The protective members 170 are favorably provided such that the upper ends thereof correspond to the upper end of the mattress part 200 and the lower ends thereof correspond to the lower ends of the auxiliary frame members 160.

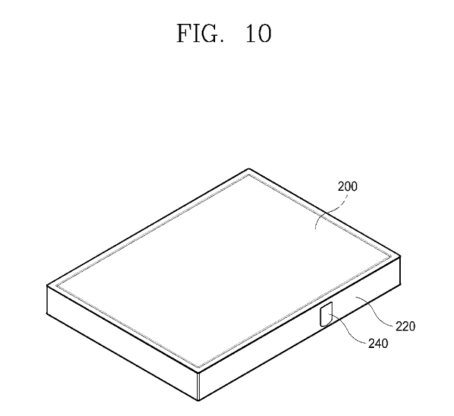

FIG. 10 illustrates a state in which the frame part 100 and the mattress part 200 are surrounded by the first cover 220.

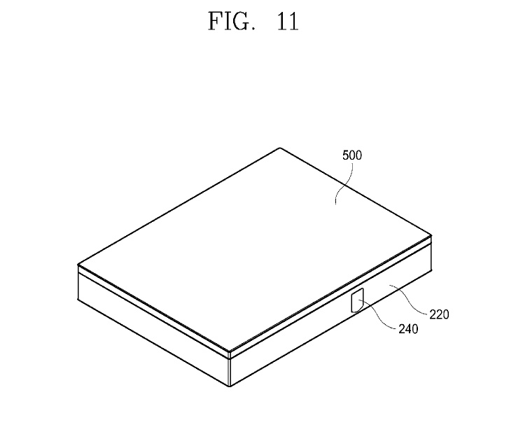

FIG. 11 illustrates a state in which the first cover 220 and the upper mat part 500 are coupled.

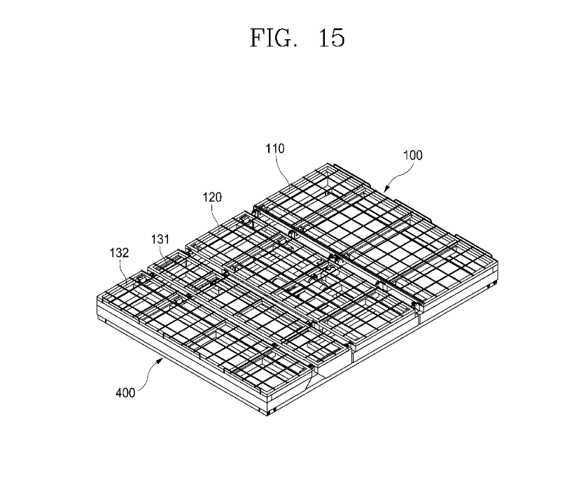

Hereinafter, with reference to FIGS. 15 to 20, an operation state of the frame part 100 operated by the drive part 300 will be illustrated.

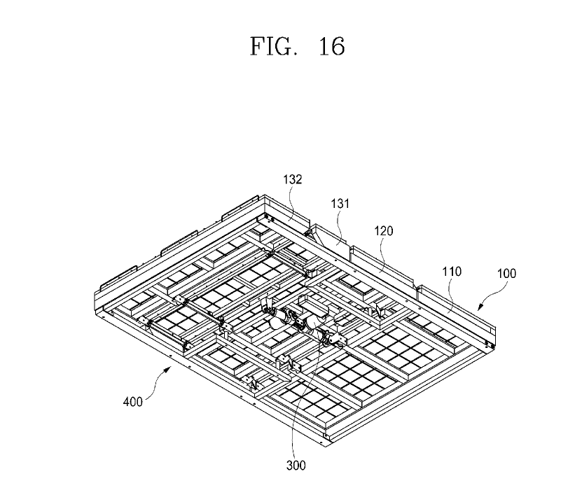

FIGS. 15, 17 and 19 are perspective views from over the frame part, and FIGS. 16, 18, and 20 are perspective views from under the frame part.

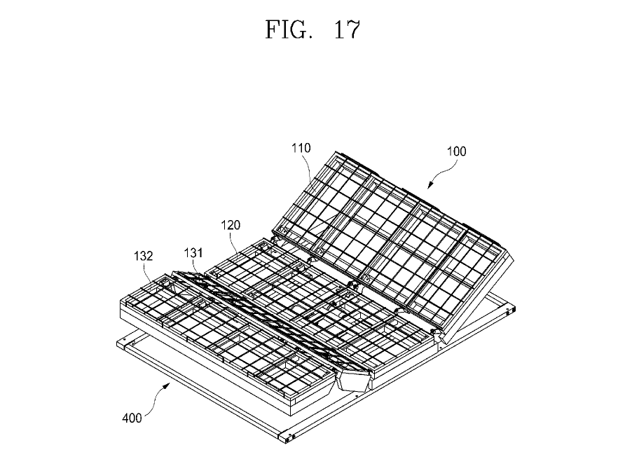

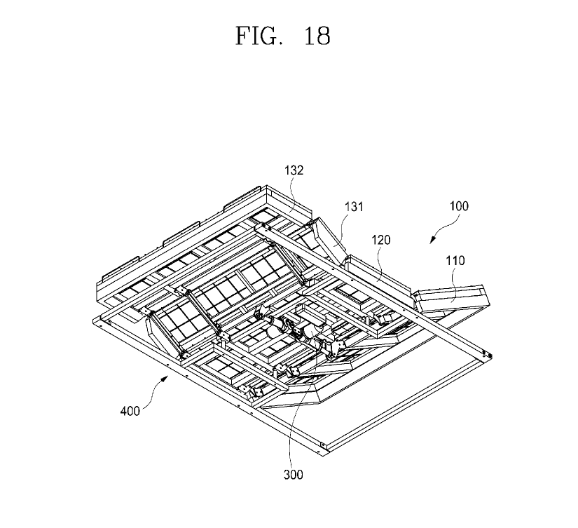

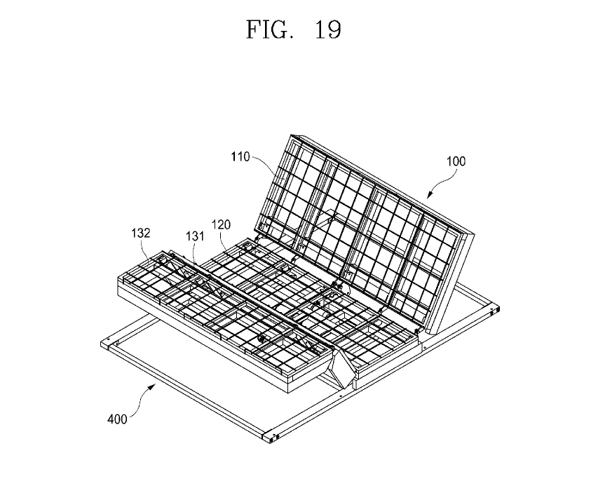

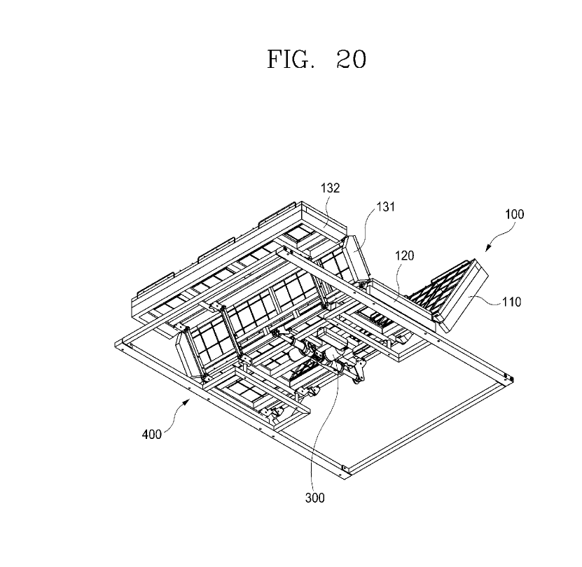

FIGS. 15 and 16 illustrate a planar state of the frame part 100. In the planar state, when the drive part 300 is operated and the cylinders are elongated, as illustrated in FIGS. 17 and 18, the upper body frame 110 and the lower body frame 131 form inclination angles relative to the fixed frame 120. At this point, the position and the angle of the second lower body frame 132 are determined according to the inclination angle of the first lower body frame 131. FIGS. 19 and 20 illustrate states in which lager inclination angles are formed compared to those in FIGS. 17 and 18.

Here, it may be found that there is no drive device or support member between the upper and lower body frames 110 and 130 and the support part 400.

So far, specific embodiments of the present invention have been described with reference to the accompanying drawings, but it is obvious that the scope of the present invention include technical idea set forth in the following claims and their modifications and equivalents.

What is claimed is:

1. An electric bed combining mattress comprising:
a frame part comprising a plurality of segment frames foldably connected so as to form an inclination angle with adjacent segment frames;
a mattress part mounted on the frame part; a drive part configured to drive the segment frames so that the segment frames are folded; and
a support part configured to support the lower portion of the frame part.

2. The electric bed combining mattress of claim 1, wherein the plurality of segment frames are divided into and include an upper body frame, a fixed frame, and a lower body frame, wherein the fixed frame is fixed to the support part, and the upper body frame and the lower body frame are foldably connected so as to respectively form inclination angles with the fixed frame.

3. The electric bed combining mattress of claim 2, wherein the lower body frame comprises a plurality of segment frames foldably connected to the fixed frame.

4. The electric bed combining mattress of claim 1, wherein the frame part comprises laying plates which are provided on an upper portion thereof and in which a plurality of wire parts cross each other, wherein the mattress part is deflected by the weight thereof into respective spaces between the wire parts.

5. The electric bed combining mattress of claim 1, wherein the frame part comprises detachment prevention guides provided on both longitudinal ends thereof and configured to prevent the mattress part from being detached.

6. The electric bed combining mattress of claim 1, wherein the frame part comprises auxiliary frame parts on a lower peripheral portions thereof formed by division of segmented portions of the frame part.

7. The electric bed combining mattress of claim 6, wherein the auxiliary frame members are formed of high-hardness elastic bodies.

8. The electric bed combining mattress of claim 1, wherein the frame part comprises protective members each configured to cover an outside of a peripheral portion thereof, wherein the protective members each have a portion corresponding to a segmented portion of the frame part and formed of a material having relatively higher stretchability than other portions.

9. The electric bed combining mattress of claim 8, wherein the portion formed of the material having high stretchability is formed to be gradually widened downward.

10. The electric bed combining mattress of claim 1, further comprising an upper mat part provided on the mattress part and attached to/detached from a first cover configured to surround outside surfaces of the frame part and the mattress part.

11. The electric bed combining mattress of claim 2, wherein the drive part comprises” an upper body drive part configured to drive the upper body frame; and a lower body drive part configured to drive the lower body frame, wherein the upper body drive part and the lower body drive part are provided only to a lower region of the fixed frame.

12. The electric bed combining mattress of claim 2, wherein the support part comprises: support members; and fixing members configured to fix the fixed frame to the support members, wherein the support members each comprising at least two or more vertical support members disposed to be elongated in the longitudinal direction of the mattress part.

13. The electric bed combining mattress of claim 12, wherein the support members each further comprise horizontal support members configured to connect the adjacent vertical support members.

14. The electric bed combining mattress of claim 12, wherein the support members each further comprise auxiliary support members extending toward insides of respective vertical support members.

15. The electric bed combining mattress of claim 12, wherein the support part further comprises separation members detachably coupled to lower portions of the support members and configured to separate the support members from a support surface.
